(19) United States
(12) Patent Application Publication
(10) Pub. No.: US 2007/0144227 A1
(43) Pub. Date: Jun. 28, 2007

(54) Dual action lock for keys

(76) Inventor: Chien-Yung Huang, Banciao City (TW)

Correspondence Address: BACON & THOMAS, PLLC, 625 SLATERS LANE, FOURTH FLOOR, ALEXANDRIA, VA, 22314, US

(21) Appl. No.: 11/601,695

(22) Filed: Nov. 20, 2006

(30) Foreign Application Priority Data
Dec. 23, 2005 (TW) 094222483

(51) Int. Cl. E05B 29/04

(52) U.S. Cl. 70/492

(57) ABSTRACT

A dual action lock for keys has a core and a housing. The core has a key hole and pins. The key holes is formed in the core and allows the key to be inserted into the core. The pins are slidably mounted inside of the core. The housing has a through hole. The through hole is formed through the housing and holds the core inside. When different keys are inserted into the core, the expansions of the pins out of the core will be changed to make the core to be selectively turned clockwise, counter-clockwise or both direction. Accordingly, the lock can have an ability of performing multiple functions as at least two or more locks.

### BACKGROUND OF THE INVENTION

1. Field of the Invention

The present invention relates to a lock, and more particularity to a dual action lock for keys that achieves ability of at least two or more locks performing in a single lock.

2. Description of Related Art

A conventional lock assembly in accordance with the prior art comprises a lock and a key. The lock has a core. The core has multiple pins. The pins are slidely mounted inside of the core. The key is able to insert into the core and pushes the pins into the core to make the core unlocked.

However, the conventional lock only allows a particular key to insert into. If multiple functions for lock assemblies are required, at least two or more different lock assemblies are needed so that the cost and space for installing multiple lock assemblies are high and large and this is inconvenient.

To overcome the shortcomings, the present invention provides a dual action lock for keys to obviate or mitigate the aforementioned problems.

### SUMMARY OF THE INVENTION

The primary objective of the present invention is to provide a dual action lock for keys that the lock has an ability of performing multiple functions as at least two or more locks, and the cost of manufacturing, the space for installing the lock are reduced.

A dual action lock for keys has a core and a housing. The core has a key hole and pins. The key hole is formed in the core and allows the key to be inserted into the core. The pins are slidably mounted inside of the core. The housing has a through hole. The through hole is formed through the housing and holds the core inside. When different keys are inserted into the core, the expansions of the pins out of the core will be changed to allow the core to be selectively turned clockwise, counter-clockwise or both direction.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a dual action lock for keys in accordance with the present invention;

FIG. 2 is a perspective view of a first embodiment of a key fitting with the dual action lock in FIG. 1;

FIG. 3 is an operational perspective view of the dual action lock in FIG. 1 with the key in FIG. 2 inserted into a core;

FIG. 4 is a side view in partial section of the dual action lock with the key in FIG. 3;

FIG. 5 is a cross-sectional view of the dual action lock with the key in FIG. 3;

FIG. 6 is an operational cross-sectional view of the dual action lock with the key in FIG. 3 when the key is turned 90 degrees clockwise;

FIG. 7 is an operational cross-sectional view of the dual action lock with the key in FIG. 3;

FIG. 8 is an operational cross-sectional view of the dual action lock with the key in FIG. 3 when the key is turned 90 degrees clockwise;

FIG. 9 is a perspective view of a second embodiment of a key fitting with the lock in FIG. 1;

FIG. 10 is a perspective view of the dual action lock in FIG. 1 with the key in FIG. 9 inserted into the core;

FIG. 11 is a side view in partial section of the dual action lock with the key in FIG. 10;

FIG. 12 is a cross-sectional view of the dual action lock with the key in FIG. 10;

FIG. 13 is an operational cross-sectional view of the dual action lock with the key in FIG. 10 when the key is turned 90 degrees counter-clockwise;

FIG. 14 is a cross-sectional view of the dual action lock with the key in FIG. 10;

FIG. 15 is an operational cross-sectional view of the dual action lock with the key in FIG. 10 when the key is turned 90 degrees counter-clockwise;

FIG. 16 is a perspective view of a third embodiment of a key fitting with the lock in FIG. 1;

FIG. 17 is a perspective view of the dual action lock in FIG. 1 with the key in FIG. 16 inserted into the core;

FIG. 18 is a side view in partial section of the dual action lock with the key in FIG. 17; and

FIG. 19 is a cross-sectional view of the dual action lock with the key in FIG. 17.

### DETAILED DESCRIPTION OF THE PREFERRED EMBODIMENT

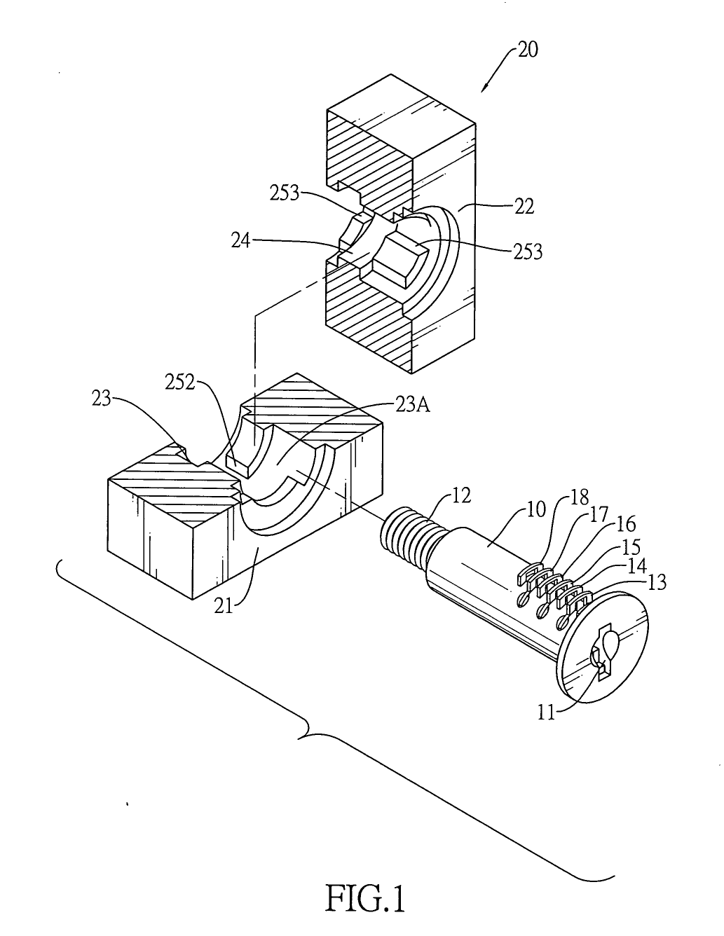

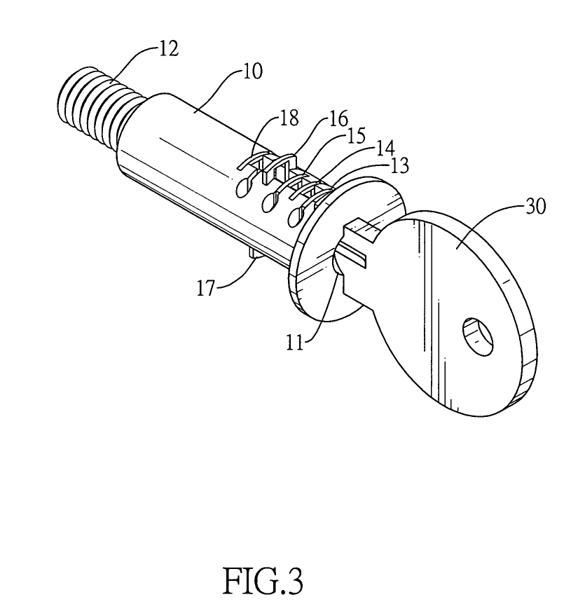

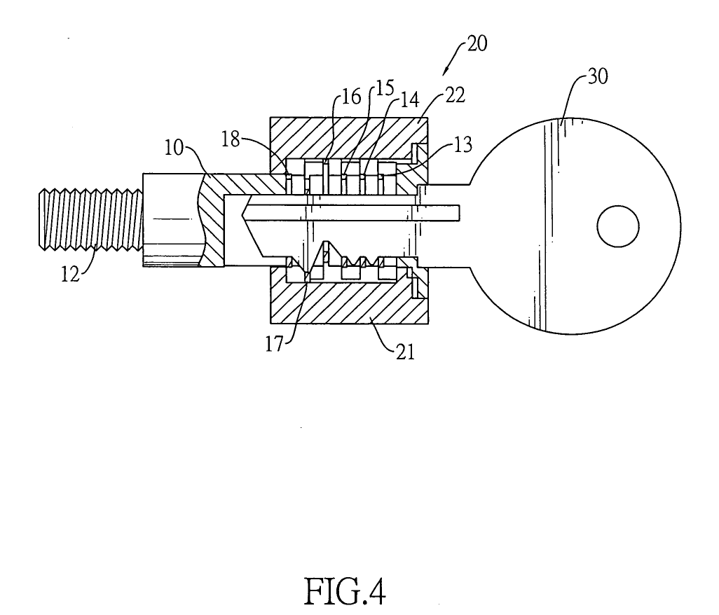

With reference to FIGS. 1, 3, 4 and 5, a dual action lock for keys in accordance with the present invention comprises a core (10) and a housing (20).

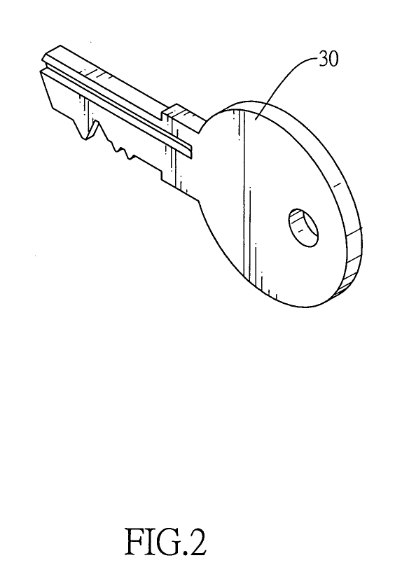

With further reference to FIGS. 2, 9 and 16, the keys (30)(40)(50) may be a first key (30), a second key (40) and a third key (50). Each key (30)(40)(50) has teeth. The teeth are formed on the each key (30)(40)(50).

The core (10) may be cylindrical and has a front end, a rear end, a side, a key hole (11), a thread (12), multiple pin holes, multiple pins (13)(14)(15)(16)(17)(18) and multiple springs (19).

The key hole (11) is formed in the front end of the core (10) and has a bottom face.

The thread (12) is formed on the rear end of the core (10) and screws with a latch to control the lock in a lock or unlock condition.

The pin holes are separately formed in the side of the core (10) and comminute with the key hole (11) of the core (10).

The pins (13)(14)(15)(16)(17)(18) may be an A pin (13), a B pin(14), a C pin (15), a D pin (16), an E pin (17), an F pin (18). The A˜F pins (13)(14)(15)(16)(17)(18) are separately and slidely mounted in the pin holes of the core (10) and each pin (13)(14)(15)(16)(17)(18) has a bottom and a top.

The springs (19) are respectively compressed between the bottoms of the A˜F pins (13)(14)(15)(16)(17)(18) and the bottom face of the key hole (11) of the core (10).

The housing (20) has a rear end, a front end and a through hole and is divided into two halves, a lower half (21) and an upper half (22).

The through hole is formed through the housing (20) from the front end to the rear end and holds the core (10) inside.

The lower half (21) has an inner face, stops (252)(254) and curve channels (23)(23A). The stops (252)(254) are formed separately on the inner face of the lower half (21). The curve channels (23)(23A) are formed on the inner face of the lower half (21) and correspond respectively to the stops (252)(254).

The upper half (22) has an inner face, stops (251)(253) and curve channels (24)(24A). The stops (251)(253) are formed separately on the inner face of the upper half (22). The curve channels (24)(24A) are formed on the inner face of the upper half (22) and correspond respectively to the stops (251)(253).

With further reference FIGS. 2, 3 and 4, when the first key (30) is inserted into the key hole (11) of the core (10), the teeth of the first key (30) allow the pins (13)(14)(15)(17)(18) to be drawn back into the core (10). The bottom of the E pin (17) extends out of the core (10). The top of the D pin (16) extends out of the core (10) so that a space is formed between the D pin (16) and the teeth of the first key (30).

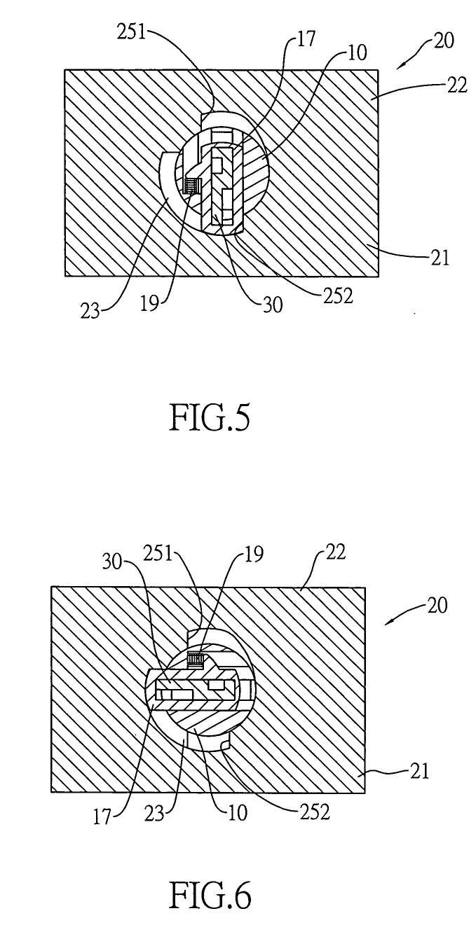

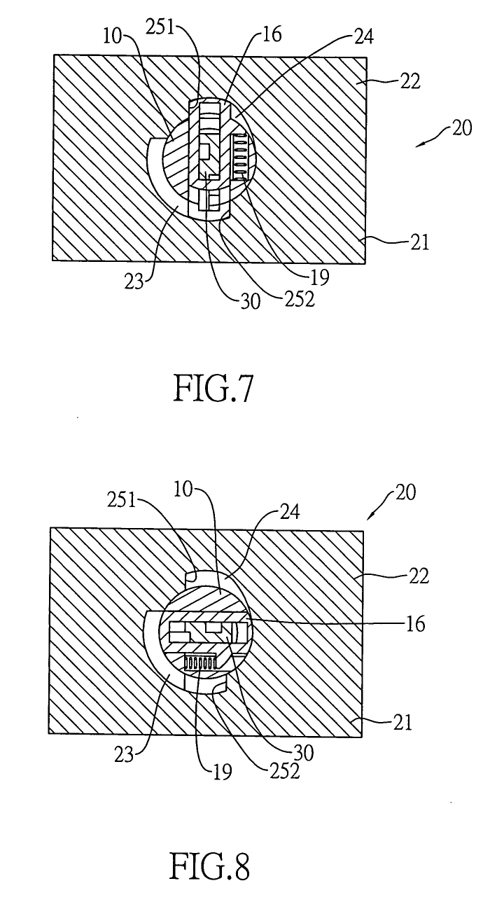

With further reference to FIGS. 5 and 7, when the first key (30) is turned counter-clockwise, the core (10) will be kept from turning with the abutments of the E pin (17) with the stop (252) on the lower half (21) and the D pin (16) with the stop (251) on the upper half (22).

With further reference to FIGS. 6 and 8, when the first key (30) is turned clockwise, the inner wall of the upper half (22) of the housing (20) will push the D pin (16) back into the core (10). When the first key (30) is turned 90 degrees clockwise, the E pin (17) slides along the curve channel (23) in the lower halve (21). Consequently, when the first key (30) is inserted into the core (10), the core (10) can be turned 90 degrees clockwise.

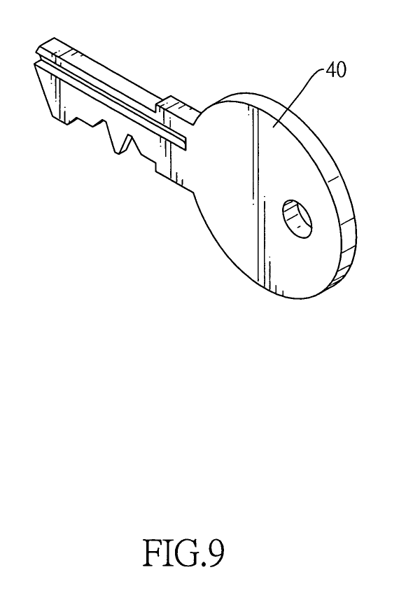

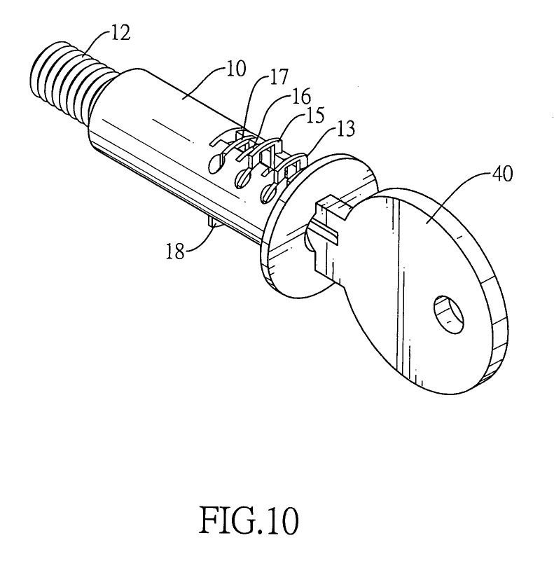

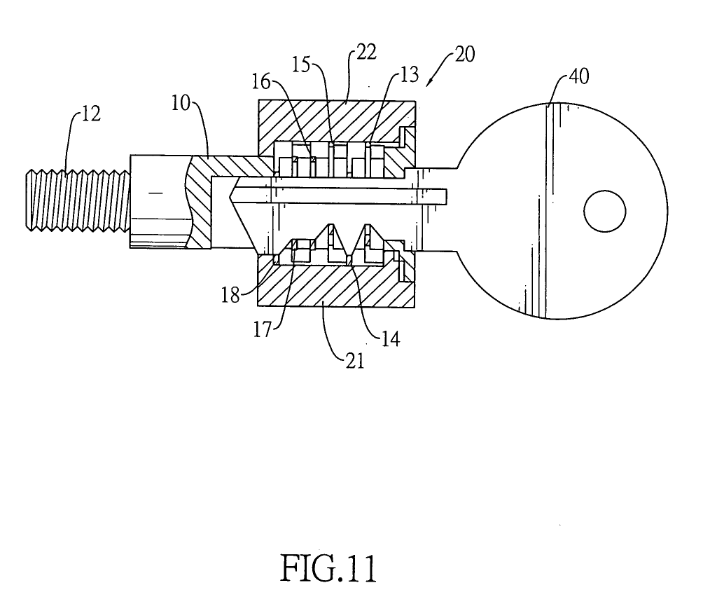

With further reference to FIGS. 9, 10 and 11, when the second key (40) is inserted into the key hole (11) of the core (10), the teeth of the second key (40) draw the D pin (16) and the E pin (17) back into the core (10), the bottoms of the B pin (14) and the F pin (18) extend out of the core (10) and the top of the C pin (15) extends out of the core (10) so that a space is formed between the teeth of the second key (40) and the C pin (15).

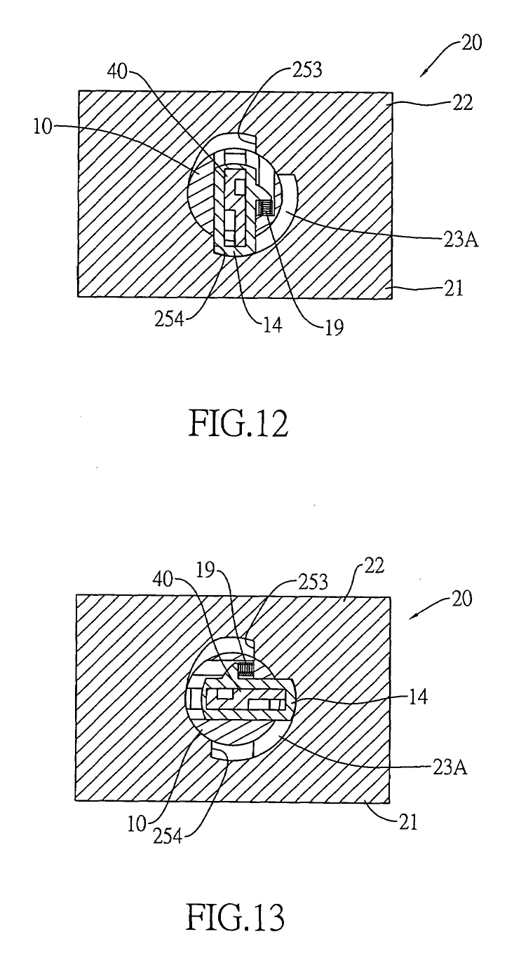

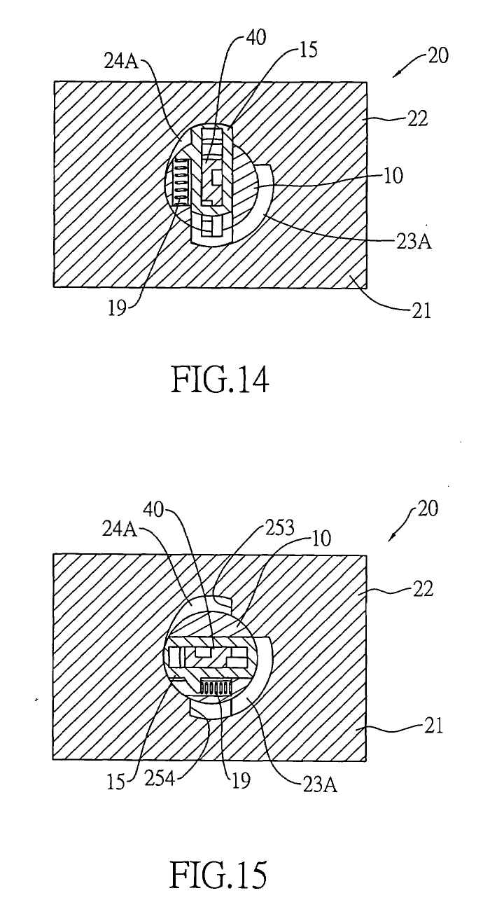

With further reference to FIGS. 12 and 14, when the second key (40) is turned clockwise, the core (10) will be kept from turning with the abutments of the stop (254) on the lower half (21) with the B pin (14) and the F pin (18) with the stop (253) on the upper half.

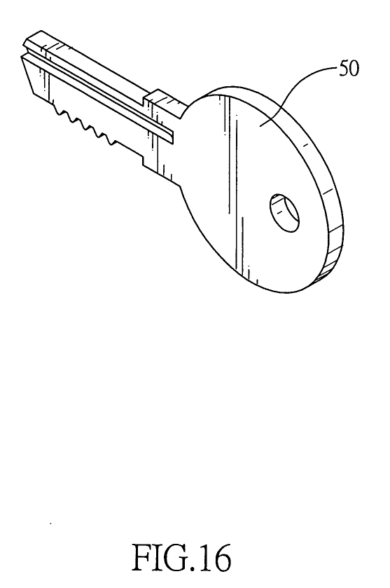

With further reference to FIGS. 13 and 15, when the second key (40) is turned counter-clockwise, the bottoms of the B pin (14) and the F pin (18) move along the curve channel (23A) of the lower half (21) to allow the core (10) to be turned 90 degrees counter-clockwise. At the same time, the top of the C pin (15) moves along the channel (24A) of the upper half (22). The inner wall of the upper half (22) will push the C pin (15) back into the core (10) during the rotation of the core (10). Accordingly, the core (10) is allowed to be turned 90 degrees counter-clockwise with the second key (40).

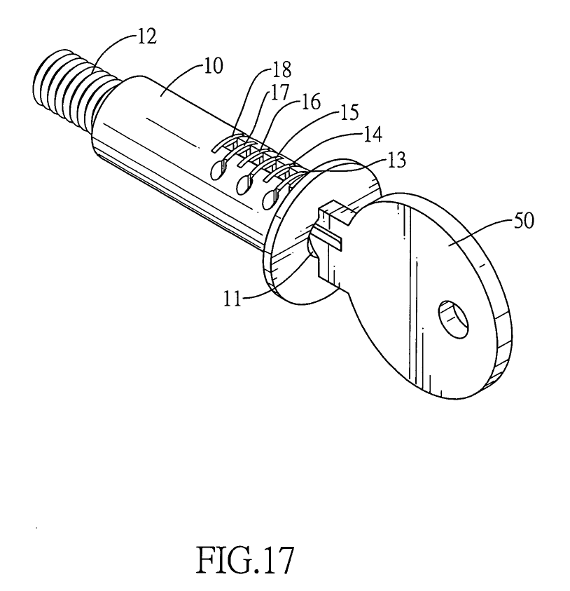

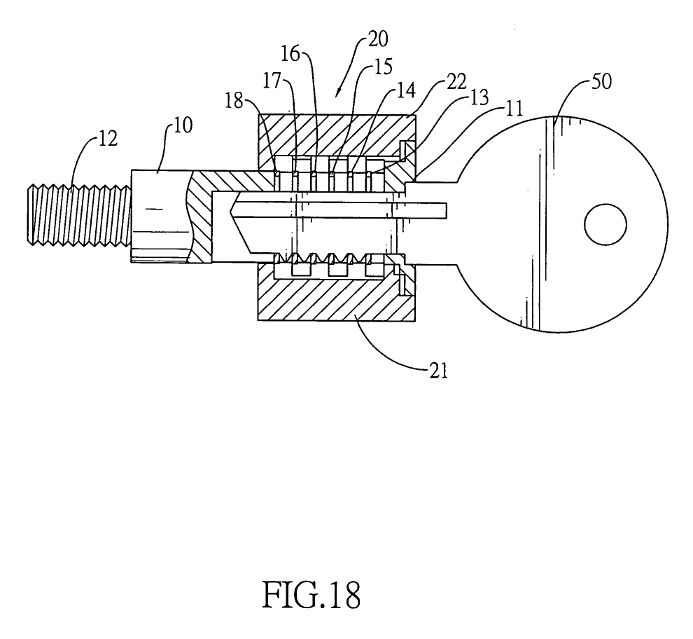

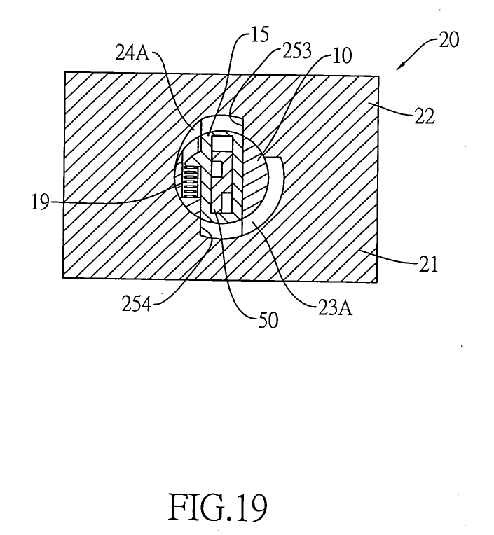

With further reference to FIGS. 16 and 17, when the third key (50) is inserted into the key hole (11) of the core (10), the pins (13)(14)(15)(16)(17)(18) are drawn back into the core (10) with the teeth on the key (50). With further reference to FIGS. 18 and 19, because the pins (13)(14)(15)(16)(17)(18) are all drawn back into the core (10), the core (10) can be turned counter-clockwise or clockwise.

Consequently, the keys (30)(40)(50) can make the core (10) to be selectively turned clockwise, counter-clockwise or both direction so that the lock can have an ability to perform as at least two or more locks and is versatile in use.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A dual action lock that can be turned to open by more than one key in more than one direction and comprising
a core having
a front end;
a rear end;
a side;
a key hole formed in the front end of the core and having a bottom face;
multiple pin holes separately formed in the side of the core and comminuting with the key hole of the core;
multiple pins respectively and slidably mounted in the pin holes of the core and each pin having
a bottom; and
a top; and
multiple springs respectively compressed between the bottoms of the pins and the bottom face of the key hole of the core; and
a housing having
a rear end;
a front end; and
a through hole formed through the housing from the front end to the rear end and holding the core inside;
wherein and the housing is composed of
a lower half having an inner face, stops formed on the inner face of the lower half and curve channels formed in the inner face of the lower half and corresponding respectively to the stops; and
an upper half having an inner face, stops formed on the inner face of the upper half and curve channels formed in the inner face of the upper half and corresponding respectively to the stops on the upper half.

2. The dual action lock for keys as claimed in claim 1, wherein the core has a thread formed on the rear end of the core.
